(19) United States
(12) Patent Application Publication
(10) Pub. No.: US 2020/0297001 A1
(43) Pub. Date: Sep. 24, 2020

(54) Drink Product and Method for Making It

(71) Applicant: Ho-Chia Lu, Tainan City (TW)

(72) Inventor: Ho-Chia Lu, Tainan City (TW)

(21) Appl. No.: 16/561,107

(22) Filed: Sep. 5, 2019

(30) Foreign Application Priority Data
Mar. 20, 2019 (TW) 108109629

(51) Int. Cl. A23L 2/54; A23L 2/42; A23L 2/72; A23F 3/14

(52) U.S. Cl. CPC A23L 2/54; A23L 2/42; A23V 2002/00; A23F 3/14; A23L 2/72

(57) ABSTRACT

A method for making a tea drink includes preparing water, receiving the water in a tank, pumping a hydrogen gas into the tank and mixing the hydrogen gas with the water to form saturated hydrogen water, sterilizing the saturated hydrogen water by ultraviolet light, performing a soaking step to immerse tea leaves into the saturated hydrogen water, refrigerating and keeping the tea leaves and the saturated hydrogen water at a temperature under 15° C. during a period of time of about 24-48 hours to make cold soaked tea, and performing a sealing step to seal the cold soaked tea in a container, to make a tea drink product.

### BACKGROUND OF THE INVENTION

### 1. Field of the Invention

The present invention relates to a drinkable and, more particularly, to a drink product and a method for making it.

### 2. Description of the Related Art

A conventional method for making a drink product, comprises preparing a drink, sterilizing the drink at a high temperature to clear the bacteria, and filling the drink into a container under the vacuum condition. However, the container is made of plastic material, such as PP and the like, such that when the drink is filled into the container after the sterilizing process at a high temperature, the plasticizer in the contained is released into the drink, thereby easily causing danger to the human body. In addition, the drink is added with antioxidants, food additives, and chemical substances, thereby easily affecting the human body.

### BRIEF SUMMARY OF THE INVENTION

The primary objective of the present invention is to provide a method that performs a sterilizing process at a normal temperature to make a drink product, thereby preventing the plasticizer of the container from being released when filling and packaging the drink product at a high temperature.

In accordance with the present invention, there is provided a method for making a tea drink, comprising preparing water, receiving the water in a tank, pumping a hydrogen gas into the tank and mixing the hydrogen gas with the water to form saturated hydrogen water at a water pressure which is equal to an atmospheric pressure, sterilizing the saturated hydrogen water by ultraviolet light, performing a soaking step to immerse tea leaves into the saturated hydrogen water, refrigerating and keeping the tea leaves and the saturated hydrogen water at a temperature under 15° C. during a period of time of about 24-48 hours to make cold soaked tea, and performing a sealing step to seal the cold soaked tea in a container, to make a tea drink product. The water is drinking water, and the tank is sealed.

In accordance with the present invention, there is further provided a tea drink comprising a container, water received in the container, a hydrogen gas received in the container, and tea leaves received in the container. The tea leaves are filled into the container under a normal temperature.

In accordance with the present invention, there is further provided a method for making a cold drink, comprising preparing water, receiving the water in a tank, pumping a hydrogen gas into the tank and mixing the hydrogen gas with the water to form saturated hydrogen water at a water pressure which is equal to an atmospheric pressure, sterilizing the saturated hydrogen water by ultraviolet light, immersing a drink staple into the saturated hydrogen water, refrigerating and keeping the drink staple and the saturated hydrogen water at a temperature under 15° C. during a period of time of about 24-48 hours to make cold drink, and sealing the cold drink in a container, to make a cold drink product. The water is drinking water, and the tank is sealed.

According to one embodiment of the present invention, the hydrogen gas is pumped into the tank to mix with the water so as to form saturated hydrogen water, such that the saturated hydrogen water is almost aseptic, and the saturated hydrogen water is then sterilized by an ultraviolet light, such that the saturated hydrogen water is aseptic completely.

According to another embodiment of the present invention, the aseptic saturated hydrogen water is used to make a drink product.

According to a further embodiment of the present invention, the drink product keeps the freshness, flavor, taste and color, without needing to add any antioxidant or chemical substance.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a flow chart of a method for making a tea drink in accordance with the preferred embodiment of the present invention.

FIG. 2 is a cross-sectional operational view showing the hydrogen gas is pumped into the water.

FIG. 3 is a cross-sectional operational view showing the tea leaves are immersed in the tank.

FIG. 4 is a flow chart of a method for making a cold drink in accordance with the preferred embodiment of the present invention.

FIG. 5 is a cross-sectional operational view showing the sterilizing process by an ultraviolet light.

FIG. 6 is a perspective view of a bottle in accordance with the preferred embodiment of the present invention.

FIG. 7 is a perspective view of an aluminum foil package in accordance with the preferred embodiment of the present invention.

FIG. 8 is a perspective view showing the bottle containing tea leaves.

FIG. 9 is an exploded perspective view of the container as shown in FIG. 8.

### DETAILED DESCRIPTION OF THE INVENTION

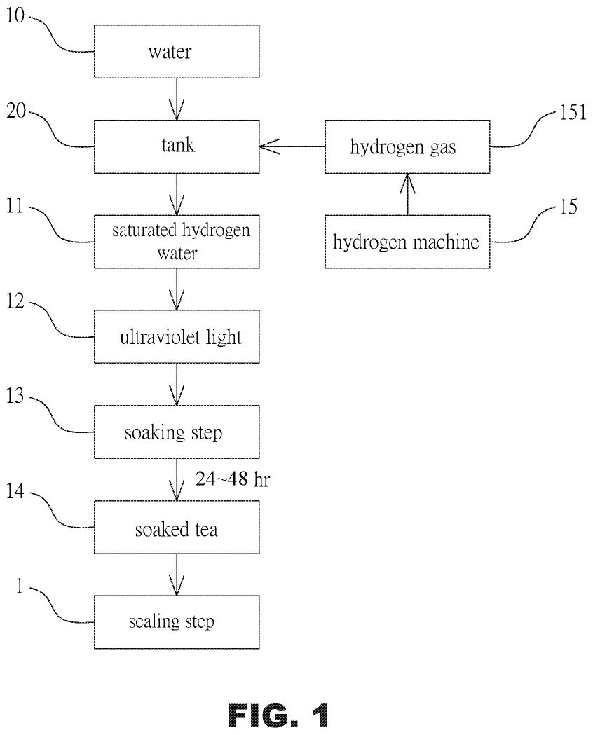

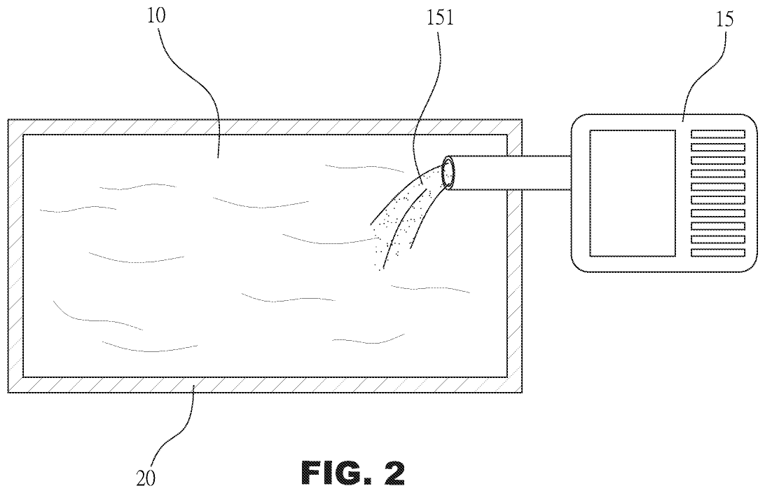

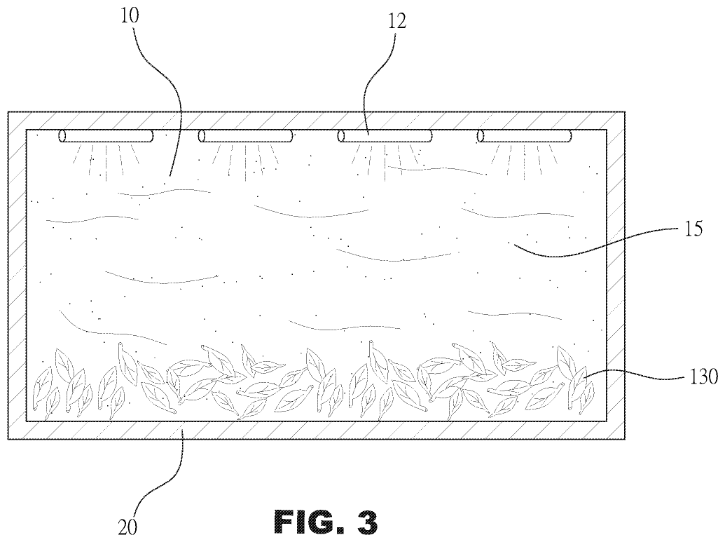

Referring to the drawings and initially to FIGS. 1-3, a method for making a tea drink in accordance with the preferred embodiment of the present invention comprises preparing water 10, receiving the water 10 in a tank 20, pumping a hydrogen gas 151 into the tank 20 as shown in FIG. 2 and mixing the hydrogen gas 151 with the water 10 to form saturated hydrogen water 11 at a water pressure which is equal to an atmospheric pressure (about 1000 PPM), sterilizing (or disinfecting) the saturated hydrogen water 11 by ultraviolet light (or radiation) 12 as shown in FIG. 3, performing a soaking step 13 to immerse tea leaves 130 into the saturated hydrogen water 11, refrigerating and keeping the tea leaves 130 and the saturated hydrogen water 11 at a temperature under 15° C. during a period of time of about 24-48 hours to make cold soaked tea 14, and performing a sealing step 1 to seal the cold soaked tea 14 in a container, to make a tea drink product. It is appreciated that, the hydrogen gas 151 isolates the bacteria contained in the air, and the saturated hydrogen water 11 provides an disinfecting effect, to clear the bacteria contained in the drink. Then, the saturated hydrogen water 11 is sterilized by the ultraviolet light 12 so that the drink is disposed at an aseptic state exactly. Then, the drink is filled and packaged. Thus, the bacteria-free drink is made under a low temperature condition.

In the preferred embodiment of the present invention, the water 10 is drinking water.

In the preferred embodiment of the present invention, the tank 20 is sealed.

In the preferred embodiment of the present invention, the container is a bottle, a can, a canister, a tin, an aluminum foil package or the like.

In the preferred embodiment of the present invention, the hydrogen gas 151 is pumped into the tank 20 by a hydrogen machine (or generator) 15.

In the preferred embodiment of the present invention, the saturated hydrogen water 11 is sterilized under a normal temperature, such that the saturated hydrogen water 11 is sterile or aseptic.

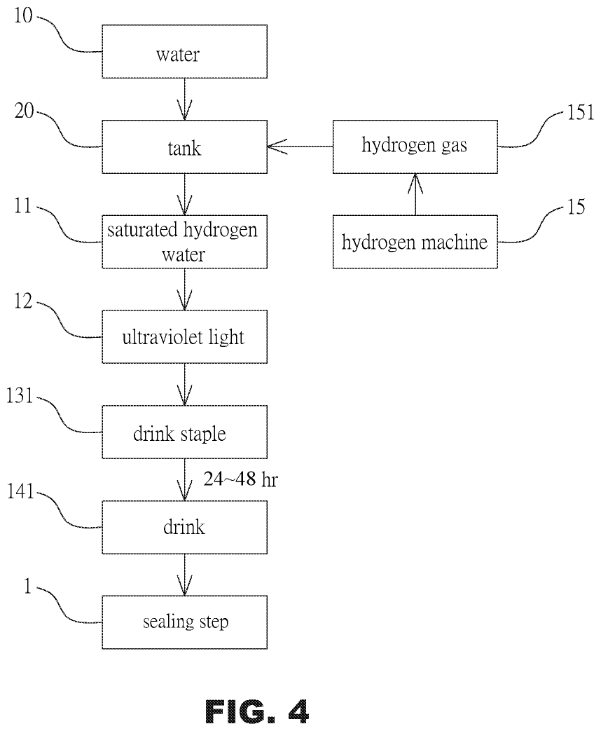

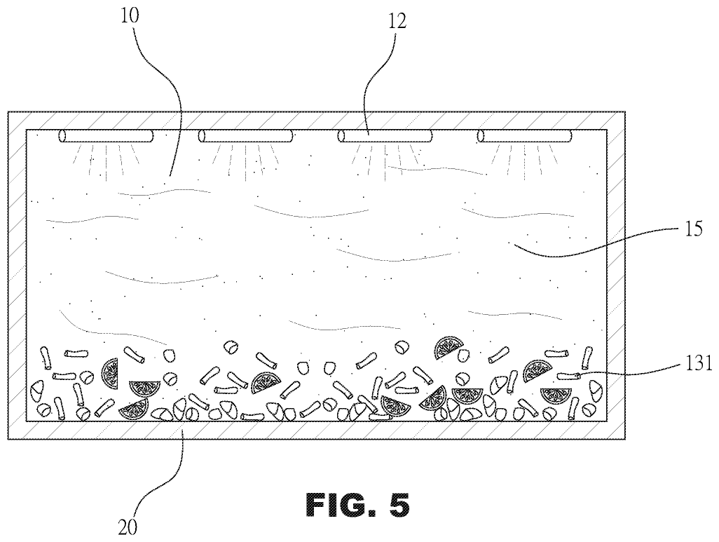

Referring to FIGS. 4 and 5, a method for making a cold drink (or beverage) in accordance with the preferred embodiment of the present invention comprises preparing water 10, receiving the water 10 in a tank 20, pumping a hydrogen gas 151 into the tank 20 and mixing the hydrogen gas 151 with the water 10 to form saturated hydrogen water 11 at a water pressure which is equal to an atmospheric pressure (about 1000 PPM), sterilizing (or disinfecting) the saturated hydrogen water 11 by ultraviolet light (or radiation) 12, immersing a drink staple 131 into the saturated hydrogen water 11 as shown in FIG. 5, refrigerating and keeping the drink staple 131 and the saturated hydrogen water 11 at a temperature under 15° C. during a period of time of about 24-48 hours to make cold drink 141, and sealing the cold drink 141 in a container, to make a cold drink product.

In the preferred embodiment of the present invention, the water 10 is drinking water.

In the preferred embodiment of the present invention, the tank 20 is sealed.

In the preferred embodiment of the present invention, the container is a bottle, a can, a canister, a tin, an aluminum foil package or the like.

In the preferred embodiment of the present invention, the hydrogen gas 151 is pumped into the tank 20 by a hydrogen machine (or generator) 15.

In the preferred embodiment of the present invention, the cold drink 141 is a juice (lemon, orange, apple or the like), coffee, milk tea or the like.

In the preferred embodiment of the present invention, the saturated hydrogen water 11 is sterilized under a normal temperature, such that the saturated hydrogen water 11 is sterile or aseptic.

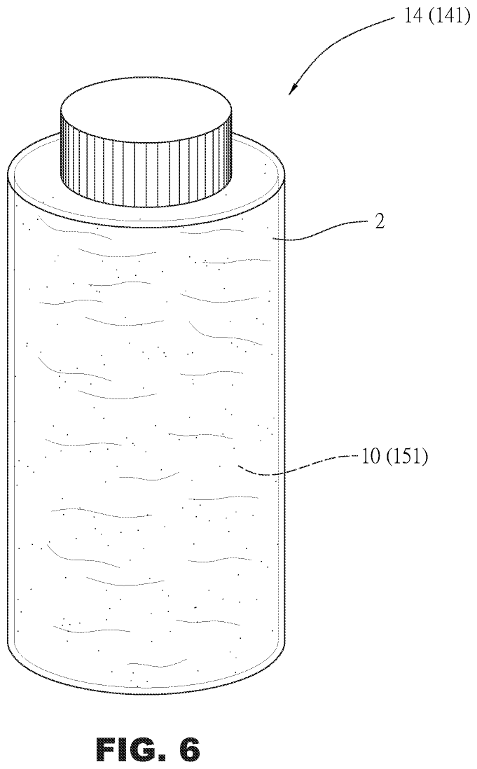

Referring to FIG. 6 with reference to FIGS. 1-5, a tea drink 14 (or cold drink 141) in accordance with the preferred embodiment of the present invention comprises a container 2, water 10 received in the container 2, a hydrogen gas 151 received in the container 2, and tea leaves 130 (or a drink staple 131) received in the container 2. The tea leaves 130 (or drink staple 131) are filled into the container 2 under a normal temperature (or an ambient temperature). In the preferred embodiment of the present invention, the container 2 is a bottle, can, canister, tin or the like. Thus, the saturated hydrogen water 11 is sterilized by the ultraviolet light 12 to extinguish the bacteria completely, such that the tea drink 14 has an enhanced quality and has a preservation time of about 8-15 days. In addition, the hydrogen gas 151 is kept in the water 10 during a period of time, such that the saturated hydrogen water 11 of the tea drink 14 has an antioxidant effect.

In comparison, the conventional drink product has to perform a sterilizing process at a high temperature, and has to add an antioxidant and a chemical substance so that the conventional drink product is preserved during a long time more than 4-6 months. However, the antioxidant and the chemical substance is harmful to the human body. In addition, the plasticizer in the container is released into the drink product during the sterilizing process at a high temperature, and easily affects the health of the human body.

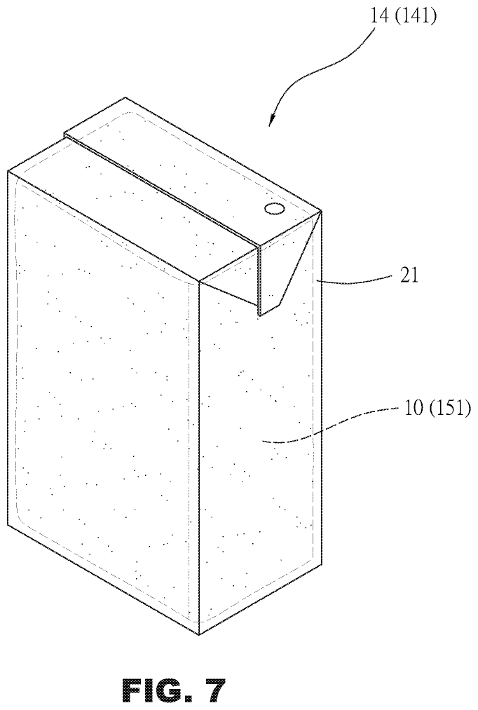

Referring to FIG. 7, the container 21 is an aluminum foil package.

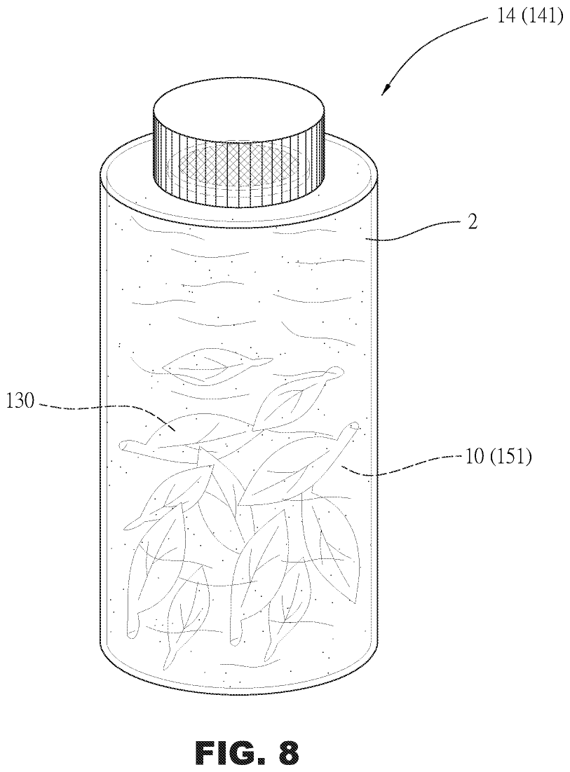

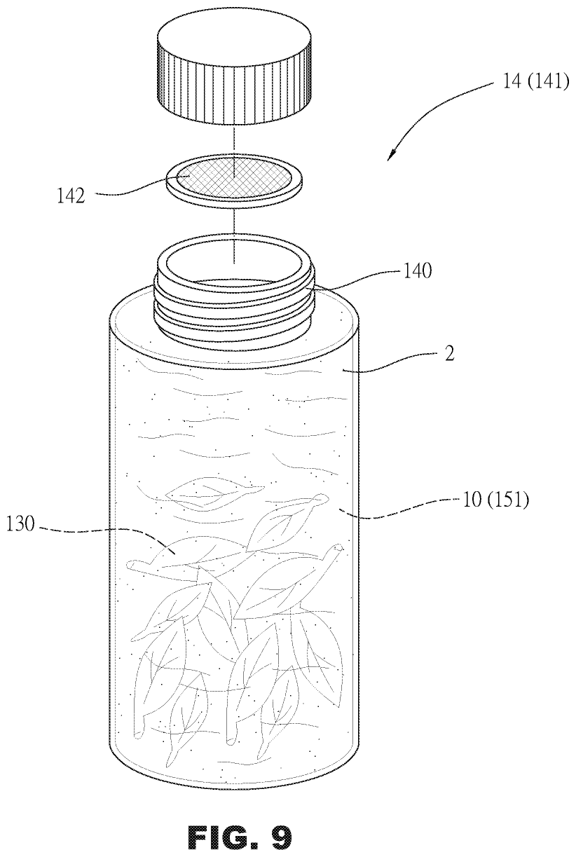

Referring to FIGS. 8 and 9, the tea leaves 130 are filled in the container 2. The container 2 is provided with a mouth 140, and a strainer 142 is mounted on the mouth 140 of the container 2 to filter the tea leaves 130, to facilitate the consumer directly drinking the tea drink 14.

Thus, the drink product does not contain any antioxidant or chemical substance during the manufacturing process such that the drink product will not do harm to the consumer. In addition, the drink product contains the hydrogen gas 151 that is helpful to the human body, so as to achieve the effect of beauty and preventive health care.

Accordingly, the drink product is made at a normal or low temperature, such that when the drink product is sealed in the container, the plasticizer in the container will not be released into the drink product. In addition, the drink product is fresh and has a great taste to the consumer. Further, the preservation date of the drink product is prolonged effectively to 8-15 days. Further, the drink product contains low calorie and low caffeine, and will not cause a burden to the human body. Further, the drink product clears the free radical, has an anti-oxidation effect, and is resistant to inflammation, such that the drink product is helpful to the human body.

In conclusion, the drink product keeps the hydrogen gas 151 in the water 10 and is sealed in the container, to achieve the sterilizing effect at a normal temperature, and to maintain the freshness, flavor, taste and color of the drink simultaneously. In addition, the drink product does not contain any food additive and is helpful to the consumer's health.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the scope of the invention.

1. A method for making a tea drink, comprising:
preparing water;
receiving the water in a tank;
pumping a hydrogen gas into the tank and mixing the hydrogen gas with the water to form saturated hydrogen water at a water pressure which is equal to an atmospheric pressure;
sterilizing the saturated hydrogen water by ultraviolet light;
performing a soaking step to immerse tea leaves into the saturated hydrogen water;
refrigerating and keeping the tea leaves and the saturated hydrogen water at a temperature under 15° C. during a period of time of about 24-48 hours to make cold soaked tea; and
performing a sealing step to seal the cold soaked tea in a container, to make a tea drink product;
wherein:
the water is drinking water; and
the tank is sealed.

2. A tea drink comprising:
a container;
water received in the container;
a hydrogen gas received in the container; and
tea leaves received in the container;
wherein:
the tea leaves are filled into the container under a normal temperature.

3. The tea drink of claim 2, wherein the tea leaves are filled in the container, the container is provided with a mouth, and a strainer is mounted on the mouth of the container to filter the tea leaves.

4. A method for making a cold drink, comprising:
preparing water;
receiving the water in a tank;
pumping a hydrogen gas into the tank and mixing the hydrogen gas with the water to form saturated hydrogen water at a water pressure which is equal to an atmospheric pressure;
sterilizing the saturated hydrogen water by ultraviolet light;
immersing a drink staple into the saturated hydrogen water;
refrigerating and keeping the drink staple and the saturated hydrogen water at a temperature under 15° C. during a period of time of about 24-48 hours to make cold drink; and
sealing the cold drink in a container, to make a cold drink product;
wherein:
the water is drinking water; and
the tank is sealed.

5. The method of claim 4, wherein the cold drink is a juice, coffee or milk tea.
